(19) United States
(12) Patent Application Publication
(10) Pub. No.: US 2007/0289914 A1
(43) Pub. Date: Dec. 20, 2007

(54) Filter with at least one membrane sputtering-coated with silver particles

(76) Inventor: Chih-Cheng Yang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/454,040

(22) Filed: Jun. 16, 2006

(51) Int. Cl. B01D 29/00

(52) U.S. Cl. 210/338; 210/500.25; 210/490; 210/507

(57) ABSTRACT

A filter that reduces microorganisms or chlorine from tap water and has at least one membrane that has at least one layer. The at least one layer is a fabric layer sputtering-coated with silver particles.

### BACKGROUND OF THE INVENTION

1. Field of the Invention

The present invention relates to a filter, especially to a filter with at least one membrane sputtering-coated with silver particles.

2. Description of the Prior Art

A filter filters a feed-in solution, lets a filtrate pass through and block impurities. The simplest example of a filter comprises at least one membrane inserted between a feeding inlet and an outlet, so that the filter filters a solution with impurities from the inlet, blocks impurities and allow a filtrate to pass through the membrane and reach the outlet.

Conventional filters are also available in other types. For example: a columnar type or a spiral-wound type.

A conventional columnar type filter comprises at least one filter material and the at least one filter material is arranged as a cylinder so that the filter has two ends and an outer surface. The filter filters a solution with impurities fed into one of the two ends, allows a concentrate to come out from the other end and permits a filtrate to pass through the at least one filter material to reach the outer surface of the filter. The at least one filter material blocks the impurities from passing through and reaching the filter's outer surface. As a result, the impurities stay in the concentrate and come out from the other end of the filter.

A conventional spiral-wound type filter comprises a filtrate collecting tube, at least one filter material and at least one feed channel spacer.

The filtrate collecting tube has two ends, a tube wall and multiple collecting through holes defined through the tube wall. The at least one filter material wraps around the tube wall of the filtrate collecting tube. The at least one feed channel spacer is a fabric layer and wraps around the at least one filter material.

A solution with impurities is fed into the feed channel spacer. The at least one filter material filters the solution, leaves a concentrate in the feed channel spacer to be later dispose of. A filtrate passes through the at least one filter material and enters the filtrate collecting tube through the collecting through holes. The impurities are blocked by the at least one filter material and are left in the concentrate.

One of the major applications of filters is to filter out the impurities suspended in tap water to make drinking water. In addition to a filter, to reduce chlorine from tap water, at least one extra device is necessarily attached to the downstream or upstream of a filter. The at least one extra device not only costs additional expenses but also expands necessary spaces.

To overcome the shortcomings, the present invention provides a filter with at least one membrane sputtering-coated with silver particles to mitigate or obviate the aforementioned problems.

### SUMMARY OF THE INVENTION

The main objective of the invention is to provide a filter that reduces microorganisms or chlorine from tap water and has at least one membrane sputtering-coated with silver particles.

The filter in accordance with the present invention has at least one membrane that comprises at least one layer; and at least one of the at least one layer is a fabric layer sputtering-coated with silver particles.

Other objectives, advantages and novel features of the invention will become more apparent from the following detailed description when taken in conjunction with the accompanying drawings.

### BRIEF DESCRIPTION OF THE DRAWINGS

FIG. 1A is a perspective view of a first embodiment of a filter with at least one membrane sputtering-coated with silver particles in accordance with the present invention.

FIG. 1B is a partial cross sectional view of a filter in FIG. 1.

FIG. 2 is a perspective view of a second embodiment of a filter with at least one membrane sputtering-coated with silver particles in accordance with the present invention.

FIG. 3 is a perspective view of a third embodiment of a filter with at least one membrane sputtering-coated with silver particles in accordance with the present invention.

### DETAILED DESCRIPTION OF THE INVENTION

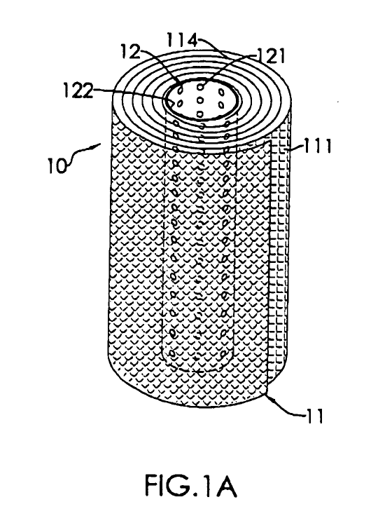

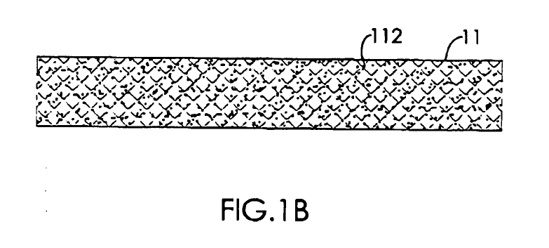

With reference to FIG. 1A, a first embodiment of a filter (10) in accordance with the present invention comprises a filtrate collecting tube (12) and at least one membrane (11).

The filtrate collecting tube (12) has two ends (122), a tube wall and multiple collecting through holes (121) defined through the tube wall.

The membrane (11) comprises a fabric layer of non-woven cloth sputtering-coated with silver particles. The membrane (11) is formed from a sheet being rectangular and having two short sides and two long sides. Lengths of the two short sides are equal to or less than a length of the filtrate collecting tube (12). The membrane (11) winds around the tube wall of the filtrate collecting tube (12), and has an exposed outer surface being an outer surface (111) of the filter (10). As the result, one of the long sides spirals to form an end face (114) of the membrane (11) wound around the tube wall.

When a tap water with impurities is applied to the outer surface (111) or the end face (114), the membrane (11) filters the tap water. A filtrate passes through the membrane (11) and enters the filtrate collecting tube (12) through the collecting through holes (121). With further reference to FIG. 1B, the membrane (11) blocks the impurities from entering the filtrate collecting tube (12), and reduces the chlorine in the tap water with the sputtering-coated silver particles (112).

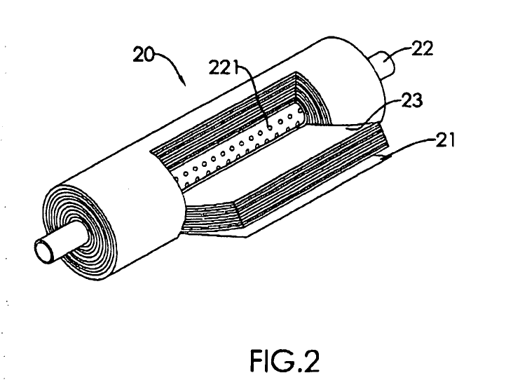

With reference to FIG. 2, a second embodiment of a filter (20) in accordance with the present invention comprises a filtrate collecting tube (22), a multi-layer filter material (23), a membrane (21) sputtering-coated with silver particles.

The filtrate collecting tube (22) has two ends, a tube wall and multiple collecting through holes (221) defined through the tube wall. The multi-layer filter material (23) wraps around the tube wall of the filtrate collecting tube (22). The membrane (21) sputtering-coated with silver particles, forms as a feed channel spacer and wraps around the multi-layer filter material (23).

When a tap water with impurities is applied to the membrane (21), the membrane (21) filters the tap water. A filtrate passes through the membrane (21) as well as the multi-layer filter material (23), and enters the filtrate collecting tube (22) through the collecting through holes (221). The membrane (21) and the multi-layer filter material (23) block the impurities from entering the filtrate collecting tube (22) as well as reducing the chlorine in the tap water with the sputtering-coated silver particles.

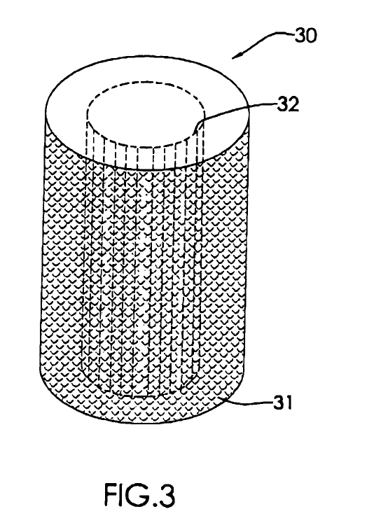

With reference to FIG. 3, a third embodiment of a filter (30) in accordance with the present invention comprises a columnar type filter (32) and a membrane (31) sputtering-coated with silver particles.

When a tap water with impurities is applied to the membrane (31), the membrane (31) filters the tap water, blocks the impurities, and allows a chlorine-reduced filtrate to passes through the membrane (31). The chlorine-reduced filtrate is then filtered by the columnar type filter (32).

A filter with at least one membrane sputtering-coated with silver particles in accordance with the present invention reduces chlorine from tap water while filtering without extra device. Therefore, the cost for manufacturing the filter is reduced.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A filter comprising at least one membrane having at least one layer being a fabric layer sputtering-coated with silver particles.

2. The filter as claimed in claim 1, wherein the fabric layer is a non-woven fabric layer.

3. The filter as claimed in claim 1, wherein the membrane is located in an outmost layer of the filter.

4. The filter as claimed in claim 1 further comprising
a filtrate collecting tube around which the at least one membrane is wrapped and having
a tube wall; and
multiple collecting through holes defined through the tube wall.

5. The filter as claimed in claim 4, wherein the at least one membrane wraps around the filtrate collecting tube and further comprises
at least one filter material, and
at least one membrane sputtering-coated with silver particles forming as a feed channel spacer.

6. The filter as claimed in claim 5, wherein the at least one filter material is a multi-layer filter material.
